(19) United States
(12) Patent Application Publication
(10) Pub. No.: US 2024/0146074 A1
(43) Pub. Date: May 2, 2024

(54) ADAPTIVE POWER SYSTEMS AND CONTROL METHODS WITH STATE-OF-CHARGE OR STATE-OF-ENERGY/POWER BALANCING

(71) Applicant: The Board of Trustees of The University of Alabama, Tuscaloosa, AL (US)

(72) Inventor: Jaber A. Abu Qahouq, Tuscaloosa, AL (US)

(21) Appl. No.: 18/498,708

(22) Filed: Oct. 31, 2023

Related U.S. Application Data
(60) Provisional application No. 63/420,832, filed on Oct. 31, 2022.

(51) Int. Cl. H02J 7/00

(52) U.S. Cl. CPC H02J 7/0019; H02J 7/0048

(57) ABSTRACT

Adaptive power systems and control methods are described herein. An example adaptive power system can include a plurality of power sources; a state-of-charge (SOC) circuit including a plurality of switches and at least one inductor, wherein the plurality of switches includes first and second switches; and a controller operably coupled to plurality of switches, the controller being configured to operate the plurality of switches in a first mode and a second mode to balance a respective SOC of each of the plurality of power sources.

### CROSS-REFERENCE TO RELATED APPLICATIONS

This application claims the benefit of U.S. provisional patent application No. 63/420,832, filed on Oct. 31, 2022, and titled “ADAPTIVE POWER SYSTEMS AND CONTROL METHODS WITH STATE-OF-CHARGE OR STATE-OF-ENERGY/POWER BALANCING,” the disclosure of which is expressly incorporated herein by reference in its entirety.

### BACKGROUND

Electrochemical energy storage devices (e.g., batteries) comprising multiple cells, battery modules, or battery packs are used in many applications including, but not limited to, electric and hybrid vehicle applications, backup or emergency power systems, renewable energy systems, consumer electronics, and medical devices, amongst many others. Certain energy storage systems may implement active cell balancing circuits. However, such systems are rarely used due to their high complexity, large dimensions, large number of parts, and high costs. It is therefore desirable to provide energy storage systems with active cell balancing electronic circuits and control methods that are easy to implement, efficient, flexible, effective, have low number of parts/components and that are inexpensive.

### SUMMARY

Example systems, methods and apparatuses for providing voltage or state of charge (SOC) balancing and state-of-energy/power management and balancing are described herein.

Embodiments of the present disclosure provide active cell balancing electronic systems, components, and control methods. In some embodiments, two inductors, or a split inductor, and two switches, are used to balance four cells, modules, or packs. In some embodiments, only two inductors, or a split inductor, and only two switches, are used to balance four cells. In various examples, the components of the active cell balancing system (e.g., two switches and two inductors) are relatively small in size/volume and relatively inexpensive for the functionality it can realize. For example, the active cell balancing system may be configured to handle the current or processing of energy needed to balance a plurality of cells (or modules or packs) without handling the current or energy that is drawn from the plurality of cells by a load being powered by the plurality of cells. In some examples, a controller that allows for continued operation at the same or desired voltage level and balancing operation with any number of disconnected cells is provided. In some examples, a controller that allows for controlling the balancing current to achieve highest efficiency during cell balancing is provided. This can be accomplished, for example, by adjusting a value of the balancing current and/or the regulated or open circuit voltage.

In accordance with some embodiments of the present disclosure, an adaptive power system is provided. The adaptive power system can include a plurality of power sources; a state-of-charge (SOC) circuit including a plurality of switches and at least one inductor, wherein the plurality of switches includes first and second switches; and a controller operably coupled to plurality of switches, the controller being configured to operate the plurality of switches in a first mode and a second mode to balance a respective SOC of each of the plurality of power sources.

In some implementations, the plurality of power sources includes four power sources or less. Alternatively, the plurality of power sources includes three power sources or less. Alternatively, the plurality of power sources includes two power sources or less.

In some implementations, the system can further include at least one open circuit terminal that corresponds to a disconnected power source. Optionally, the controller is configured to compensate for the disconnected power source to operate the plurality of switches to generate a regulated voltage between the at least one open circuit terminal while balancing the respective SOC of each of the plurality of power sources.

Optionally, the plurality of power sources includes first, second, third, and fourth power sources. In some implementations, the first and second power sources are connected in series, the third and fourth power sources are connected in series, and the series-connected first and second power sources are connected in parallel with the series-connected third and fourth power sources.

In some implementations, the plurality of switches includes only the first and second switches.

In some implementations, the plurality of switches includes only two switches for each set of four power sources.

In some implementations, the first mode is a switching mode, the controller being configured to turn the plurality of switches ON and OFF in the switching mode. Optionally, the controller is configured to select a duty cycle for the switching mode, the duty cycle controlling an amount of charge transfer among the plurality of power sources. Optionally, the first mode is configured to balance the respective SOC of one or more vertically-connected power sources of the plurality of power sources.

In some implementations, the second mode is a non-switching mode, the controller being configured to maintain the plurality of switches OFF in the non-switching mode. Optionally, the second mode is configured to balance the respective SOC of one or more horizontally-connected power sources of the plurality of power sources.

In some implementations, the controller is further configured to monitor a respective voltage and/or SOC of each of the plurality of power sources. Optionally, the controller is further configured to alternate between the first and second modes responsive to the respective voltage and/or SOC of each of the plurality of power sources. Optionally, the controller is further configured to set a current value of the at least one inductor responsive to the respective voltage and/or SOC of each of the plurality of power sources. In some implementations, the controller is optionally further configured to set a current value of the at least one inductor to maximize efficiency and/or minimize power loss.

In some implementations, the at least one inductor is a center-tapped inductor or coupled inductors.

In some implementations, the at least one inductor is a plurality of inductors. Optionally, the plurality of inductors are first and second inductors. Optionally, the plurality of inductors share a magnetic core.

In some implementations, the SOC circuit further includes a first wiring for electrically connecting the plurality of switches to the plurality of power sources. In some implementations, the system further includes a load circuit including a second wiring and a load, the second wiring for electrically connecting the load to the plurality of power sources. Optionally, the first wiring is distinct from the second wiring. Optionally, the first wiring is configured to carry a SOC balancing current. Optionally, the second wiring is configured to carry a load current or a charging current.

In some implementations, the plurality of power sources are energy storage devices such as batteries. Optionally, each of the batteries is a battery cell or a battery pack.

In some implementations, the plurality of power sources are super/ultra capacitors, direct current (DC) micro grids, or photovoltaic (PV) cells.

In accordance with some embodiments of the present disclosure, another adaptive power system in described herein. The adaptive power system can include: a plurality of power sources, wherein the plurality of power sources includes four power sources or less; a state-of-charge (SOC) circuit consisting essentially of: two switches corresponding to the plurality of power sources, at least one inductor corresponding to the plurality of power sources, and a wiring for electrically connecting the two switches and the at least one inductor to the plurality of power sources; and a controller operably coupled to the two switches, the controller being configured to operate the two switches in a first mode and a second mode to balance a respective SOC of each of the plurality of power sources.

In accordance with some embodiments of the present disclosure, another adaptive power system in described herein. The adaptive power system can include: a plurality of power sources including a set of four power sources; a state-of-charge (SOC) circuit consisting essentially of: two switches corresponding to the set of four power sources, at least one inductor corresponding to the set of four power sources, and a wiring for electrically connecting the two switches and the at least one inductor to the set of four power sources; and a controller operably coupled to the two switches, the controller being configured to operate the two switches in a first mode and a second mode to balance a respective SOC of each of the set of four power sources.

In accordance with some embodiments of the present disclosure, another adaptive power system in described herein. The adaptive power system can include: a plurality of power sources; a state-of-charge (SOC) circuit including a plurality of switches and at least one inductor, wherein the plurality of switches includes first and second switches; and a controller operably coupled to plurality of switches, the controller being configured to operate the plurality of switches in a first mode and a second mode to balance a respective terminal or open circuit voltage of each of the plurality of power sources.

In accordance with some embodiments of the present disclosure, another adaptive power system in described herein. The adaptive power system can include: a plurality of power sources; at least one open circuit terminal that corresponds to a disconnected/not present power source; a state-of-charge (SOC) circuit including a plurality of switches and at least one inductor, wherein the plurality of switches includes first and second switches; and a controller operably coupled to plurality of switches, the controller being configured to compensate for the disconnected power source to operate the plurality of switches to generate a regulated voltage between the at least one open circuit terminal while balancing a respective SOC of each of the plurality of power sources.

In accordance with some embodiments of the present disclosure, another adaptive power system in described herein. The adaptive power system can include: a plurality of power sources; a state-of-charge (SOC) circuit including a plurality of switches and at least one inductor, wherein the plurality of switches includes first and second switches; and a controller operably coupled to plurality of switches, the controller being configured to operate the plurality of switches in a first mode and a second mode to maximize efficiency and/or minimize power loss.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram of an adaptive power system/energy system circuit topology according to implementations described herein.

FIG. 2 is a diagram illustrating operation modes for switches in adaptive power systems/energy systems according to implementations described herein.

FIG. 3A, FIG. 3B, FIG. 3C, and FIG. 3D are schematic diagrams of the adaptive power system/energy system circuit topology with a disconnected power source according to implementations described herein.

FIG. 4A and FIG. 4B are schematic diagrams of the adaptive power system/energy system circuit topology with two disconnected power source according to implementations described herein.

FIG. 5A and FIG. 5B are schematic diagrams of the adaptive power system/energy system circuit topology with two disconnected power source according to other implementations described herein.

FIG. 6A and FIG. 6B are schematic diagrams of the adaptive power system/energy system circuit topology with two disconnected power source according to yet other implementations described herein.

FIG. 7A, FIG. 7B, FIG. 7C, and FIG. 7D are schematic diagrams of the adaptive power system/energy system circuit topology including a single power source according to implementations described herein.

FIG. 8A is a diagram illustrating a controller according to implementations described herein.

FIG. 8B is a diagram illustrating a controller according to other implementations described herein.

FIG. 9 is a schematic diagram of an adaptive power system/energy system circuit topology extended to more than four power sources according to implementations described herein.

FIG. 10 is a schematic diagram of an adaptive power system/energy system circuit topology extended to more than four power sources according to other implementations described herein.

FIG. 11 is a flow diagram illustrating a method for estimating open circuit voltage according to implementations described herein.

FIG. 12 is a flow diagram illustrating a method for estimating energy storage device resistance according to implementations described herein.

FIG. 13 is a schematic diagram of an adaptive power system/energy system circuit topology according to implementations described herein.

FIG. 14 is a schematic diagram of an adaptive power system/energy system circuit topology including an auxiliary load or charging source according to implementations described herein.

FIG. 15 is an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for a battery, it will become evident to those skilled in the art that the implementations are not limited thereto, but are applicable for other energy storage devices such as a supercapacitor or another type of electrochemical device or semiconductor device, among others.

Systems and methods for balancing SOC or state-of-energy of a plurality of power sources are described herein. It is important to balance SOC or state-of-energy, particularly during charging and discharging operations, to avoid or minimize risks of overcharging/discharging, damage, destruction, or fire. In implementations described herein, the SOC or state-of-energy balancing schemes are active, i.e., energy is transferred between power sources in the system. Optionally, in some implementations, energy is transferred to the load or from another source, which in addition to energy transfer between power sources. This is in contrast to passive schemes where energy is merely dissipated via resistors. An example power source is an energy storage device such as a battery or other electrochemical device or non-electrochemical device (e.g., supercapacitor or solar cell). A battery may refer to a battery cell or a plurality of battery cells (e.g., a battery pack or a battery module). As used herein, state-of-energy (or power) is a measure of how much energy (or power) is available or can be drawn from the source (or supplied/taken by one or more loads). For example, the amount of energy that is available from a solar panel under given irradiance level, from a battery, from a capacitor, or from a power grid, among others. Balancing can be for state of charge, state of energy, voltages, a currents, or for the amount of energy or power drawn from a source or consumed by a load. Additionally, balancing can be to make the above quantities equal, or it can be to make their values non-equal to predetermined values (for example, one value is double of the other value). As used herein, the term state of charge (SOC) refers to a measure of the level of charge of an energy storage device. SOC can be expressed as a ratio of the current level of charge of the energy storage device to its capacity. In some implementations, SOC may be estimated by measuring voltage of the energy storage device. It should be understood that energy storage devices are provided only as example power sources. This disclosure contemplates that the systems and methods described herein may be used with other power sources, which may include, but are not limited to, a supercapacitor, an ultracapacitor, a direct current (DC) microgrid (to balance state-of-power, energy, voltage, or current), or a photovoltaic (PV) cell to balance state-of-power, energy, voltage, or current).

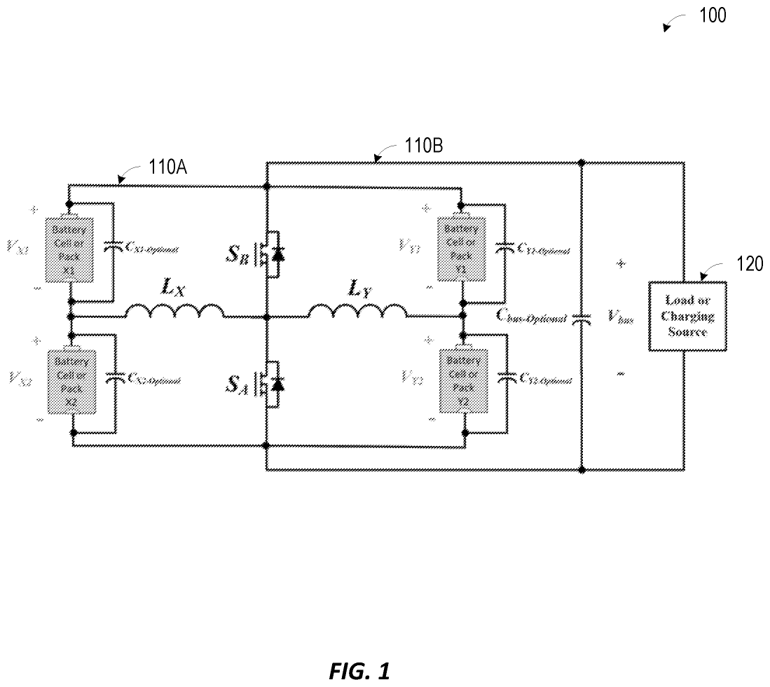

Referring now to FIG. 1, a schematic diagram illustrating an example adaptive power system/energy system 100 is shown. This disclosure contemplates that the system 100 can be used with any device, system, or equipment that requires energy storage to operate such as electric and hybrid vehicles, backup or emergency power systems, renewable energy systems, consumer electronics, and medical systems. The system 100 includes four batteries (cells, modules, or packs) X1, X2, Y1, Y2; and a SOC circuit including two switches S_{A}, S_{B} and two inductors L_{X}, L_{Y}. Optionally, inductors L_{X}, L_{Y} may share a magnetic core. Alternatively, although two inductors are shown in FIG. 1, this disclosure contemplates that the system 100 can include one inductor, for example, a center-tapped inductor. Additionally, as shown in FIG. 1, the SOC circuit includes a first wiring 110A that electrically connects the four batteries X1, X2, Y1, Y2 and two switches S_{A}, S_{B}. The SOC circuit is configured to carry the SOC balancing current. The system 100 also includes a load circuit (or charging circuit) including a second wiring 110B and a load 120 (or a charging source). The load circuit (or charging circuit) is configured to carry the load current (or charging current). It should be understood that the SOC balancing current is expected to be relatively smaller than the load or charging current. Thus, the first wiring 110A, which is distinct from the second wiring 110B, and its components (e.g., switches, inductor(s)) can be designed to accommodate a relatively smaller current. Additionally, the SOC circuit only needs to be activated when there is a SOC imbalance.

As described herein, the system 100 of FIG. 1 is able to balance the State-Of-Charge (SOC) between four or less batteries (cells or packs) using two switches and one or more inductors (e.g., one inductor tapped from the middle, or two inductors). In other words, the system 100 requires a SOC circuit including two switches and one or more inductors to balance the SOC between a set of four or less batteries (cells or packs). Optionally, in some implementations, the system 100 is able to balance the SOC between the set of four or less batteries (cells or packs) using only two switches and one or more inductors. Additionally, it should be understood that implementations of FIG. 1 are described for balancing SOC. It should be understood that the system 100 can be used to balance voltages between the set of four or less batteries (cells or packs) using two switches and one or more inductors.

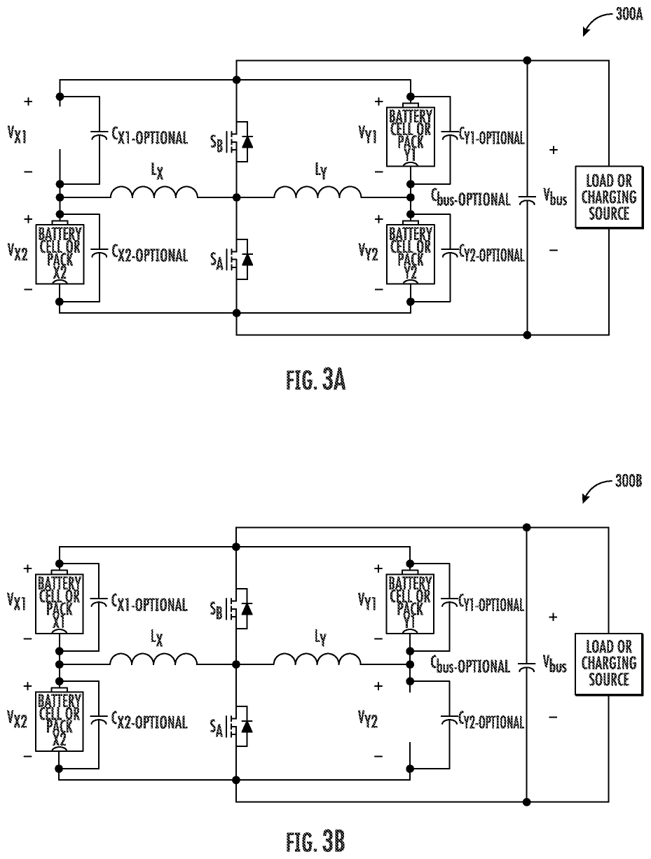

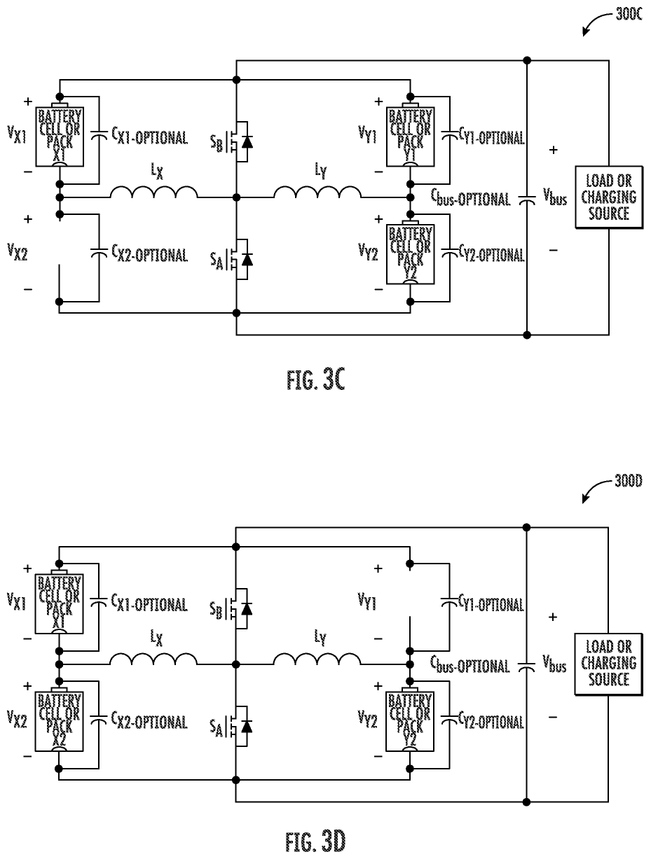

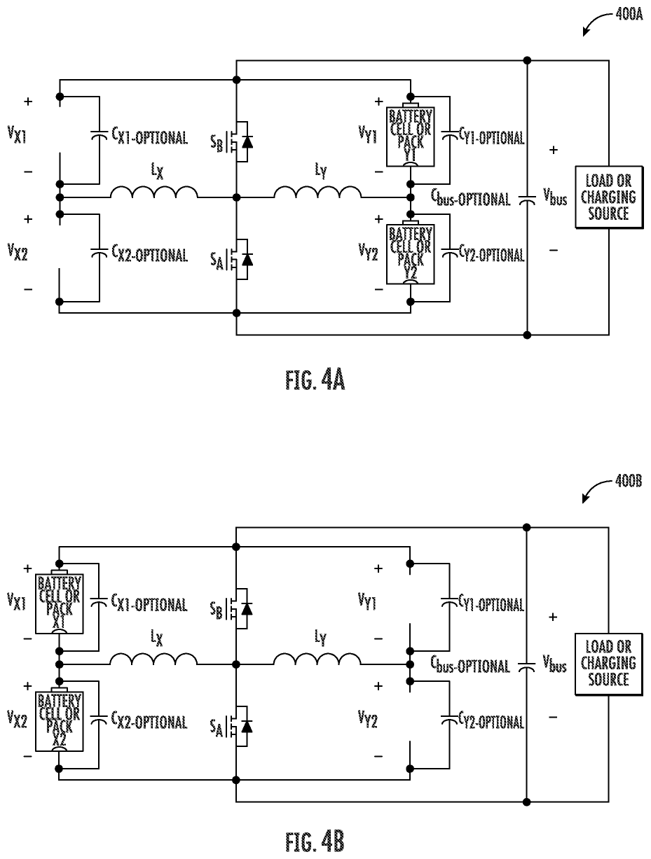

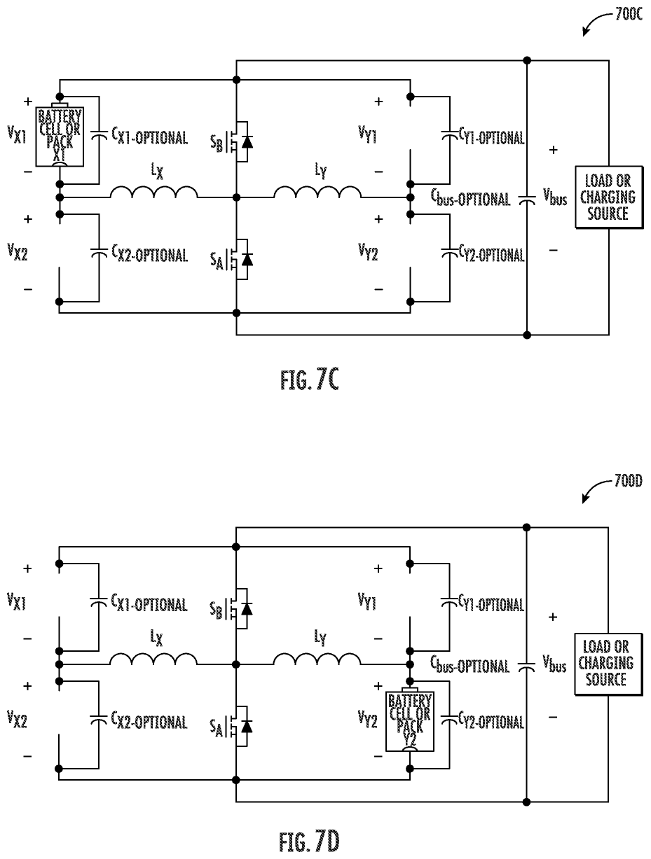

The system described herein can operate with one, two, three, or four batteries present out of the four batteries (i.e., can operate with any number of cells) as described in more detail herein. For example, FIG. 1 illustrates implementations of a system with all four batteries present. On the other hand, FIGS. 3A-3D illustrate implementations of a system where one of four batteries is disconnected or missing. FIGS. 4A-4B, 5A-5B, and 6A-6B illustrate implementations of a system where two of four batteries are disconnected or missing. FIGS. 7A-7D illustrate implementations of a system where three of four batteries are disconnected or missing. In each of FIGS. 3A-7B, there is a respective open circuit terminal corresponding to a disconnected or missing power source. In FIGS. 3A-7B, the systems operate in a manner to substitute for the open circuit voltage as if no battery is disconnected or missing.

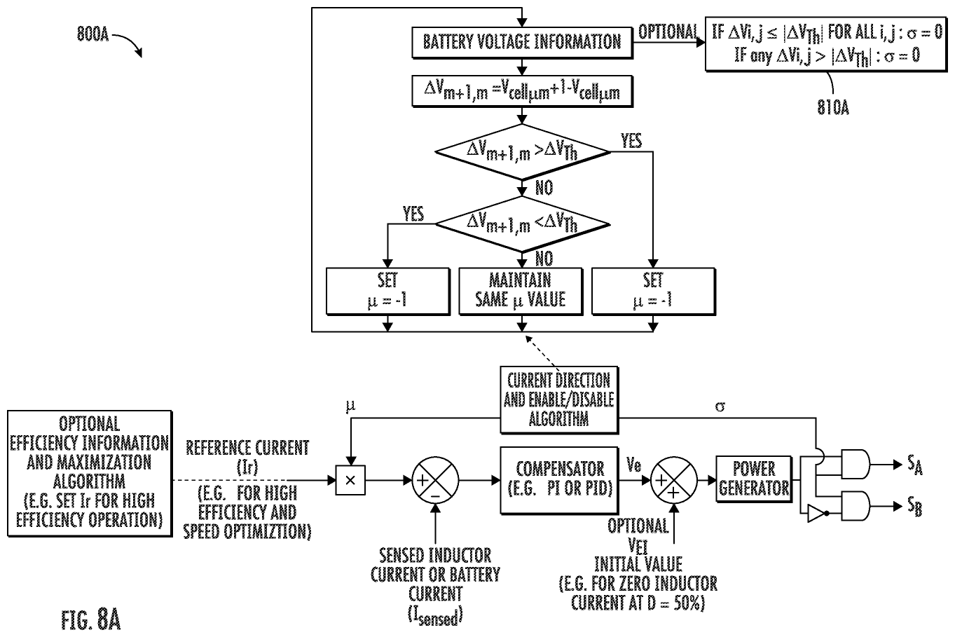

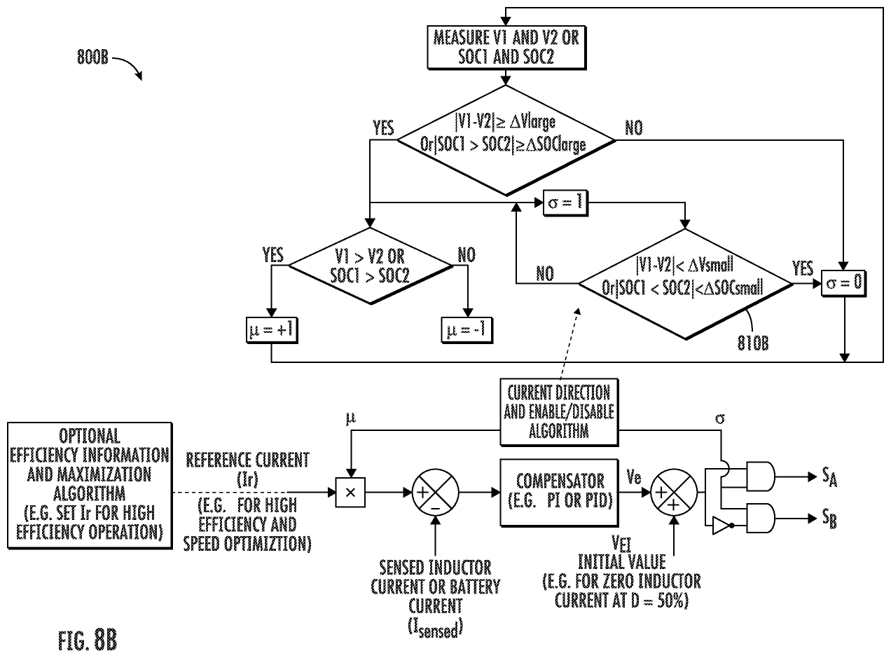

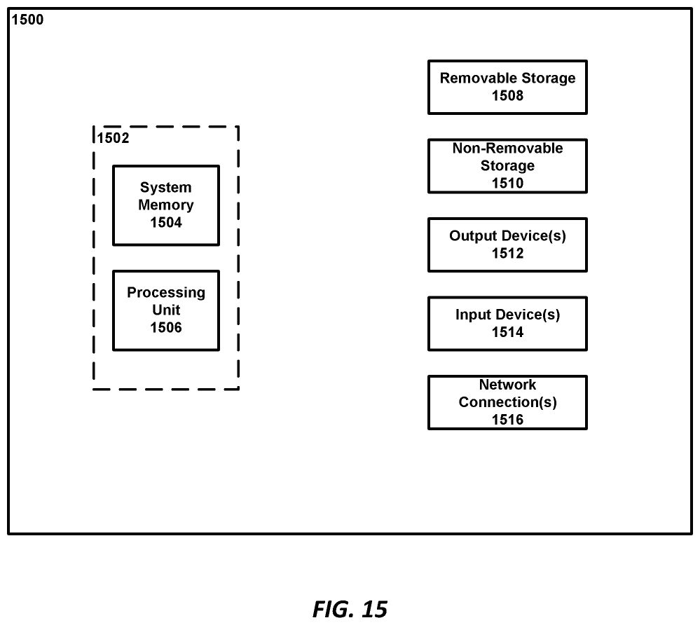

Referring again to FIG. 1, in various embodiments, the system 100 includes a controller that is operably coupled to the switches S_{A}, S_{B}. This disclosure contemplates that the controller may be the controller shown in FIG. 8A or FIG. 8B. Optionally, the controller may also include at least a processor and memory (e.g., the basic configuration is illustrated in FIG. 15 by dashed line 1502) for performing one or more of the logical operations shown in FIG. 8A or FIG. 8B. The controller is configured to generate one or more control signals for operating the switches S_{A}, S_{B}. For example, as described below, the controller is configured to operate the switches S_{A}, S_{B} in a first mode (switching mode) and a second mode (non-switching mode). The switches S_{A}, S_{B} can be turned ON and OFF in different sequences. It should be understood that each component depicted in FIG. 1 and described throughout the present disclosure are not limited to the example that is depicted. For example, each battery (e.g., X1) can be or comprise any electrical system, device, system, or network that can supply and source power and/or current. For example, each of the batteries shown in the diagrams could be replaced by a DC micro-grid or a supercapacitor/ultracapacitor.

The configuration depicted in FIG. 1 provides only two switches (S_{A} and S_{B}) and two inductors (L_{X} and L_{Y}), which may be on a single core and/or single device. In various examples, the switches and inductors can be controlled such that a voltage or state of charge balancing is achieved for the four batteries (X1, X2, Y1, and Y2). The depicted circuit can carry a balancing current without carrying a load or charging source current and therefore it is relatively small. In some embodiments, the circuit is only active when there is an imbalance.

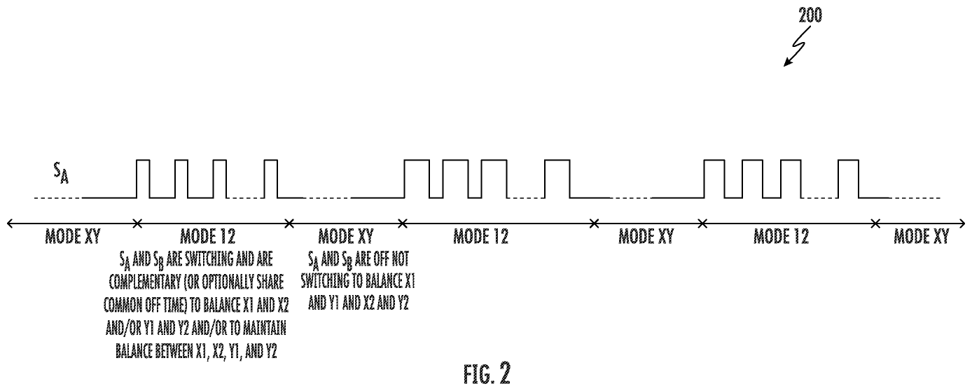

Referring now to FIG. 2, a flow diagram illustrating an example switching method 200 that can be used in conjunction with the adaptive power system 100 depicted in FIG. 1, in accordance with certain embodiments of the present disclosure. In particular, FIG. 2 depicts using two operation modes to balance the SOC between the four batteries. In a switching mode, the controller is configured to turn the plurality of switches ON and OFF. In this mode, the controller selects a duty cycle for controlling the amount of charge transfer between the batteries. In a non-switching mode, the controller is configured to maintain the plurality of switches OFF.

As illustrated, in Mode 12, switches S_{A} and S_{B} are switching and are complementary (or optionally share a common OFF time) to balance Battery X1 and Battery X2, and/or Battery Y1 and Battery Y2, and/or to maintain balance SOC or voltages between X1, X2, Y1, and Y2. The amount of charge transferred between the batteries is a function of the duty cycle (the ratio between the ON time and the switching period). Mode 12 is also referred to herein as the switching mode. As further illustrated, in Mode XY, switches S_{A} and S_{B} are OFF and therefore not switching to balance the SOC between X1 and Y1 and between X2 and Y2. When switches S_{A} and S_{B} are OFF, X1 and Y1 become connected in parallel and X2 and Y2 become connected in parallel due to the existence of the inductor(s) which act as a wire/short circuit connecting the middle point between X1 and X2 to the middle point between Y1 and Y2. Mode XY is also referred to herein as the non-switching mode.

The controller can alternate between Mode 12 and Mode XY such that the desired SOC or voltage balancing is achieved. Mode 12 transfers charge vertically, i.e., between vertically-connected batteries. Mode 12 therefore balances the SOC or voltage between vertically-connected Battery X1 and Battery X2 and/or between vertically-connected Battery Y1 and Battery Y2. Mode XY transfers charge horizontally, i.e., between horizontally-connected batteries (in parallel when the switches are not switching). Mode XY therefore balances the SOC or voltage between horizontally-connected Battery X1 and Battery Y1 and/or between horizontally-connected Battery X2 and Battery Y2. Alternating between Mode 12 and Mode XY effectively allows this system to transfer charges between all four batteries using the two switches and the inductor(s).

Referring again to FIG. 1, the voltage V_{bus} is equal to the sum of voltages Vₓ₁ and Vₓ₂ or V_{y1} and V_{y2}. A load 120 can be connected across V_{bus} during discharging (when energy is drawn from batteries) or a charging source can be connected to charge the batteries. In either case, SOC or voltage balancing can be performed as described above during discharging and discharging.

Referring now to FIGS. 3A-3D, schematic diagrams illustrating example systems 300A, 300B, 300C, and 300D where one of a plurality of batteries (e.g., one X battery or one Y battery) is non-operational or not present are provided. In FIG. 3A, battery X1 is disconnected or missing, and the open circuit terminal is shown as V_{X1}. In FIG. 3B, battery Y2 is disconnected or missing, and the open circuit terminal is shown as V_{Y2}. In FIG. 3C, battery X2 is disconnected or missing, and the open circuit terminal is shown as V_{X2}. In FIG. 3D, battery Y1 is disconnected or missing, and the open circuit terminal is shown as V_{Y1}.

In each of the examples shown in FIGS. 3A-3D, the voltage V_{bus} will still be the sum of two battery voltages and SOC or voltage balancing can be achieved in a similar manner as described herein. However, there may be more frequent charge transfer between the three operational (e.g., plugged in or inserted) batteries since the current drawn by the discharging load or supplied by the charging source will not be distributed equally between the batteries at all times and without appropriate control as discussed above.

Referring now to FIG. 4A and FIG. 4B, schematic diagrams illustrating example systems 400A and 400B where either the two X batteries or the two Y batteries are non-operational or not present are provided. In FIG. 4A, battery X1 and battery X2 are disconnected or missing, and the open circuit terminals are shown as V_{X1} and V_{X2}. In FIG. 4B, battery Y1 and battery Y2 are disconnected or missing, and the open circuit terminals are shown as V_{Y1} and V_{Y2}.

In each of the examples shown in FIG. 4A and FIG. 4B, the voltage V_{bus} will still be the sum of two battery voltages and SOC or voltage balancing can be achieved in a similar manner as described herein.

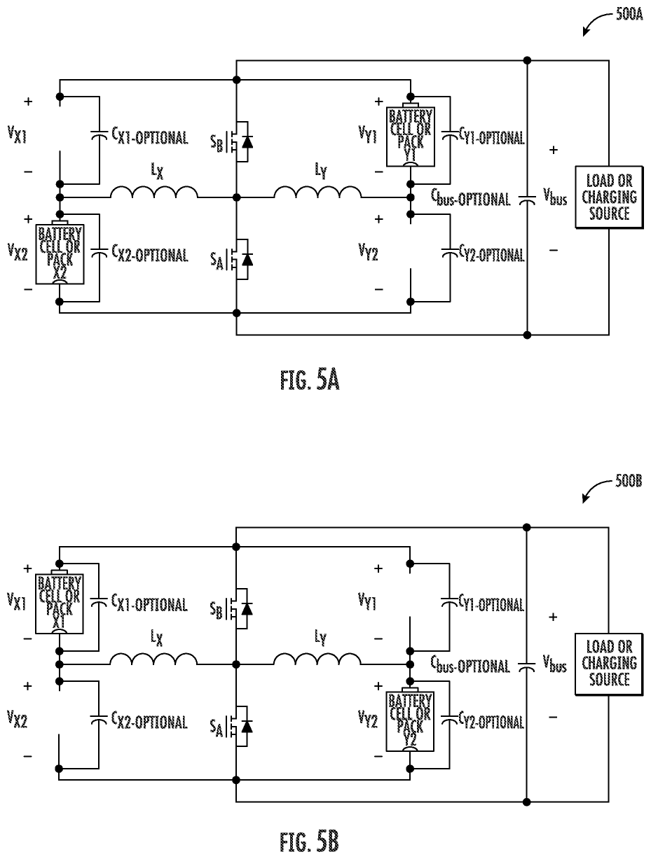

Referring now to FIG. 5A and FIG. 5B, schematic diagrams illustrating example systems 500A and 500B where one X battery and one Y battery are non-operational or not present are provided. In FIG. 5A, battery X1 and battery Y2 are disconnected or missing, and the open circuit terminals are shown as V_{X1} and V_{Y2}. In FIG. 5B, battery X2 and battery Y1 are disconnected or missing, and the open circuit terminals are shown as V_{X2} and V_{Y1}.

In each of the examples shown in FIGS. 5A and 5B, the voltage V_{bus} will still be the sum of two battery voltages and SOC or voltage balancing can be achieved in a similar manner as described herein.

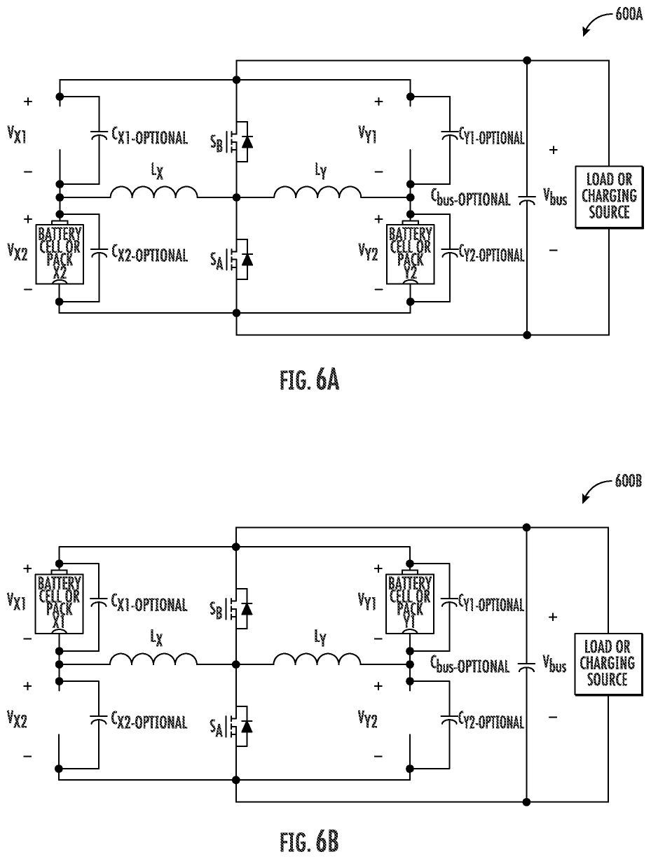

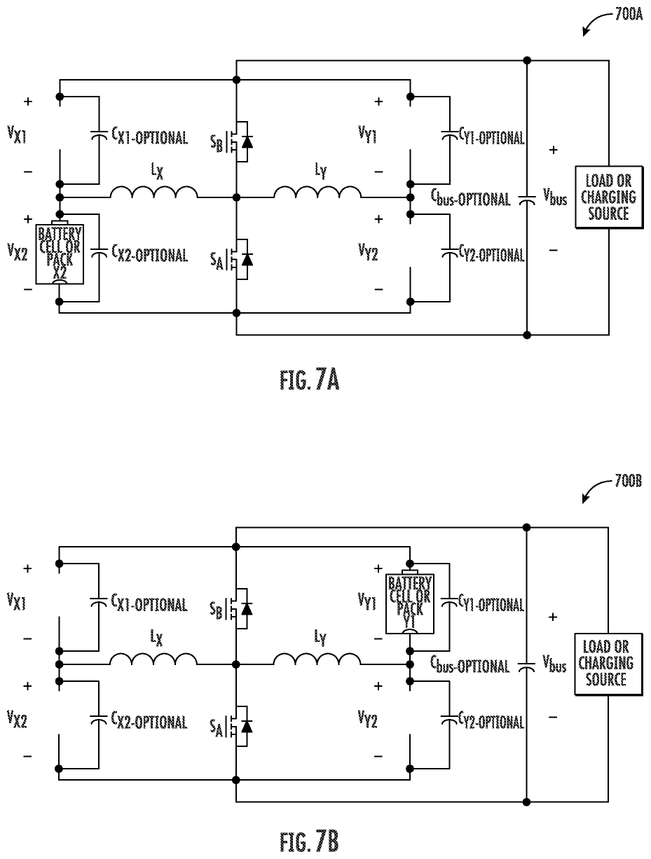

Referring now to FIG. 6A and FIG. 6B, schematic diagrams illustrating example systems 600A and 600B where one X battery and one Y battery are non-operational or not present are provided. In FIG. 6A, battery X1 and battery Y1 are disconnected or missing, and the open circuit terminals are shown as V_{X1} and V_{Y1}. In FIG. 6B, battery X2 and battery Y2 are disconnected or missing, and the open circuit terminals are shown as V_{X2} and V_{Y2}.

In each of the examples depicted in FIG. 6A and FIG. 6B, the switches S_{A}, S_{B} can be controlled such that the voltages across the terminals with the not present batteries can be generated such that the voltage V_{bus} can be maintained at levels as if the batteries are present or at another desired level. For example, if each cell has a voltage of 4 Volts (V) under given SOC, then V_{bus} will be 8 V. Accordingly, the voltage value of V_{bus} can be mainlined (e.g., at 8 V) even in an instance in which the two batteries are non-operational or not present.

Referring now to FIGS. 7A-7D, schematic diagrams illustrating example systems 700A, 700B, 700C, and 700D where only one battery is present, and all the other batteries are non-operational or not present are provided. In FIG. 7A, battery X1, battery Y1, and battery Y2 are disconnected or missing, and the open circuit terminals are shown as V_{X1}, V_{Y1}, and V_{Y2}. In FIG. 7B, battery X1, battery X2, and battery Y2 are disconnected or missing, and the open circuit terminals are shown as V_{X1}, V_{X2}, and V_{Y2}. In FIG. 7C, battery X2, battery Y1, and battery Y2 are disconnected or missing, and the open circuit terminals are shown as V_{X2}, V_{Y1}, and V_{Y2}. In FIG. 7D, battery X1, battery X2, and battery Y1 are disconnected or missing, and the open circuit terminals are shown as V_{X1}, V_{X2}, and V_{Y1}.

In each of the examples depicted in FIGS. 7A-7D, SOC or voltage balancing is not required since there is only one battery. The switches can be controlled with a duty cycle such that a regulated V_{bus} voltage is achieved similar to the example depicted in FIGS. 6A-6B above. However, in the examples depicted in FIGS. 7A-7D, the switches S_{A}, S_{B} do not need to be controlled to balance SOC or voltage and the duty cycle can be selected such that V_{bus} is well regulated at the desired value.

Referring now to FIG. 8A, a schematic diagram depicting an example controller 800A for battery voltage balancing in accordance with certain embodiments of the present disclosure is provided. Although not shown in FIG. 8A, it should be understood that the controller 800A can be used for SOC balancing. In some embodiments, the inductor (or inductors) needs to only carry the current needed to balance voltage values or SOC values (therefore they are relatively small and do not need to carry the load or source current at the bus). For example, as described above, the inductor (e.g., inductors L_{X}, L_{Y} in FIG. 1) are part of the SOC circuit (see e.g., SOC circuit in FIG. 1). The example controller 800A can set the value of the inductor current such that the system operates at high or maximum efficiency such that both high efficiency and balancing speed are achieved.

As depicted in FIG. 8A, the direction of the inductor current (see μ) depends on whether the upper cell or the lower cell (each two adjacent battery cells) of each two switches has a higher voltage. This is represented by the local voltage difference ΔV_{m+1,m}=ΔVₘ₊₁−ΔVₘ for each two adjacent cells.

If ΔV_{m+1,m} is larger than the voltage difference threshold value ΔV_{Th}, the inductor current is commanded by the controller to be positive by setting the value of μ to +1 in order to transfer charge from Battery “m+1” to Battery “m.” If ΔV_{m+1,m} is smaller than −ΔV_{Th}, the inductor current is commanded by the controller to be negative by setting the value of μ to −1 in order to transfer charge from Battery “m” to Battery “m+1.” If the voltage difference is between −ΔV_{Th} and ΔV_{Th}, the value of μ is maintained at its current value until the voltage difference reaches one of the other limits (ΔV_{Th} or −ΔV_{Th}).

While the switches (see S_{A}, S_{B}) can be kept operating all the time, the switches can optionally be disabled once the balanced condition is reached in order to save some power loss. This ensures that the SOC circuit is only active when there is a voltage or SOC imbalance in the system. The balanced condition is reached when all voltage differences between all battery cells in the battery pack are between −ΔV_{Th} and ΔV_{Th} at the same time. The enable/disable logic 810A is shown in the top portion of FIG. 8A, where ΔVᵢⱼ represents a general expression for all voltage differences in the pack. The output of the enable/disable logic is the parameter a which has the value of 1 to enable balancing operation and the value of 0 to disable balancing operation.

Referring now to FIG. 8B, a schematic diagram depicting another example controller 800B for battery voltage or SOC balancing in accordance with certain embodiments of the present disclosure is provided. Similar to FIG. 8A, the inductor (or inductors) needs to only carry the current needed to balance voltage values or SOC values (therefore they are relatively small and do not need to carry the load or source current at the bus). For example, as described above, the inductor (e.g., inductors L_{X}, L_{Y} in FIG. 1) are part of the SOC circuit (see e.g., SOC circuit in FIG. 1). The example controller 800B can set the value of the inductor current such that the system operates at high or maximum efficiency in order to achieve both high efficiency and balancing speed. The operations of FIG. 8B are described with regard to two batteries V1 and V2. It should be understood that the operations can be applied to systems having more than two batteries, for example, as described with regard to FIG. 8A.

As depicted in FIG. 8B, voltages (V1, V2) or SOC (SOC1, SOC2) are measured and compared to determine the direction of the inductor current (see μ). This is represented by the local voltage difference |V1−V2|≥ΔV_{Large} or |SOC1−VOC2|≥ΔSOC_{Large} for each two adjacent cells. The direction of inductor current depends on whether battery cells of each of two switches has a higher voltage or SOC. If V1>V2 or SOC1>SOC2, the inductor current is commanded by the controller to be positive by setting the value of μ to +1 in order to transfer charge from Battery V1 to Battery V2. If V1<V2 or SOC1<SOC2, the inductor current is commanded by the controller to be negative by setting the value of μ to −1 in order to transfer charge from Battery V2 to Battery V1.

While the switches (see S_{A}, S_{B}) can be kept operating all the time, the switches can optionally be disabled once the balanced condition is reached in order to save some power loss. This ensures that the SOC circuit is only active when there is a voltage or SOC imbalance in the system. The balanced condition is reached when all voltage differences or SOC differences between all battery cells in the battery pack satisfy the condition |V1−V2|<ΔVₛₘₐₗₗ or |SOC1−VOC2|<ΔSOCₛₘₐₗₗ. The enable/disable logic 810B is shown in FIG. 8B. The output of the enable/disable logic is the parameter a which has the value of 1 to enable balancing operation and the value of 0 to disable balancing operation.

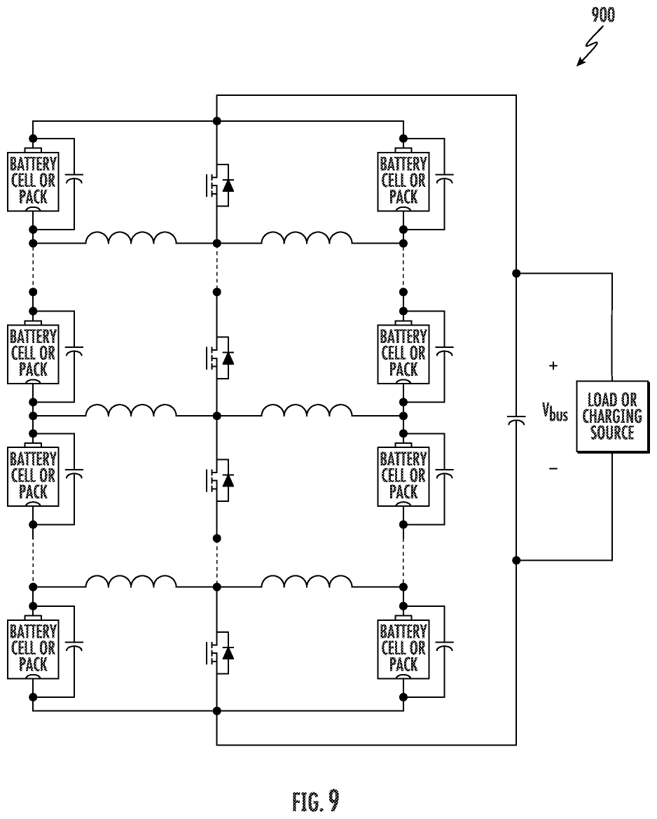

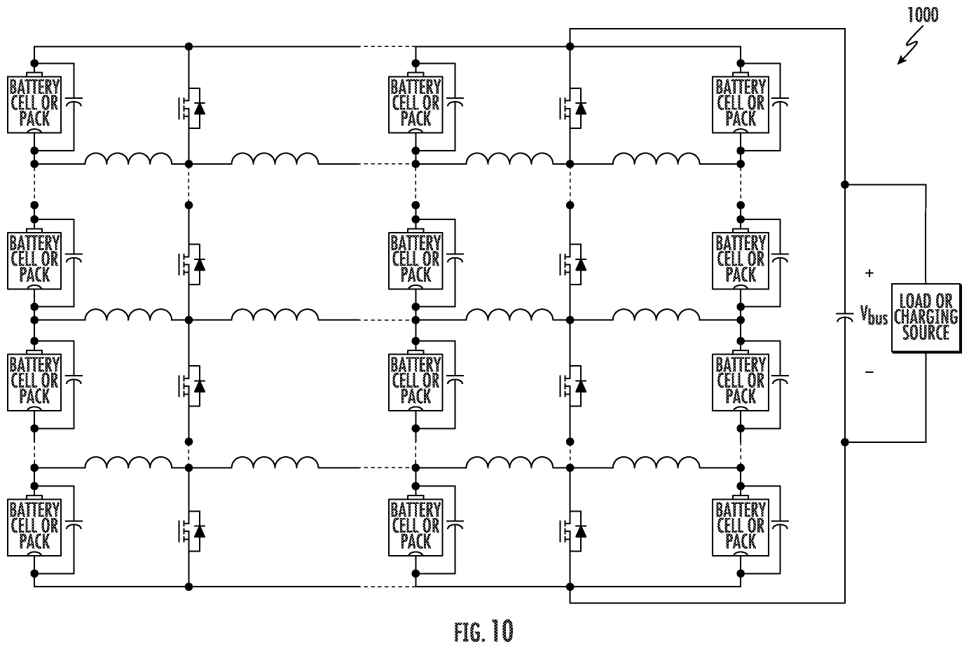

Referring now to FIG. 9, a schematic diagram depicting an example system 900 in accordance with certain embodiments of the present disclosure is provided. In particular, FIG. 9 illustrates how the system 900 can be extended for a higher number of batteries (as shown, eight batteries). As shown in FIG. 9, the SOC circuit for each set of four batteries includes two switches and at least one inductor.

Referring now to FIG. 10, another schematic diagram depicting an example system 1000 in accordance with certain embodiments of the present disclosure is provided. In particular, FIG. 10 illustrates how the system 1000 can be extended for a higher number of batteries (as shown, twelve batteries). As shown in FIG. 10, the SOC circuit for each set of four batteries includes two switches and at least one inductor.

In some embodiments, one or more of the batteries (or any device, system, or network that can source and sink power/current) can be a photovoltaic (PV) solar cell or panel such that it can charge the other batteries (or any device, system, or network that can source and sink power/current) and/or provide the energy needed for balancing operations. Example applications include any device, system, or equipment that requires energy storage to operate such as Electric and Hybrid Vehicles, backup or emergency power systems, renewable energy systems, consumer electronics, and medical systems, among many others. In some embodiments, the batteries can also be any device, system or network that can supply and source power/current. For example, each of the batteries shown in the diagrams could be replaced by a DC micro-grid or a supercapacitor/ultracapacitor.

In another embodiment, instead of balancing the terminal voltages of the batteries (V1 through Vm, or Vx1 through Vxm, or Vy1 through Vym, where m is the number of batteries), the controller can extract and balance the open circuit voltages (Voc1 through Vocm) of the battery cells (since they are more accurate representation of the SOC values). To balance open circuit voltages of battery cells, the voltage drop across the series resistance Rₛ of each battery cell needs to be compensated for.

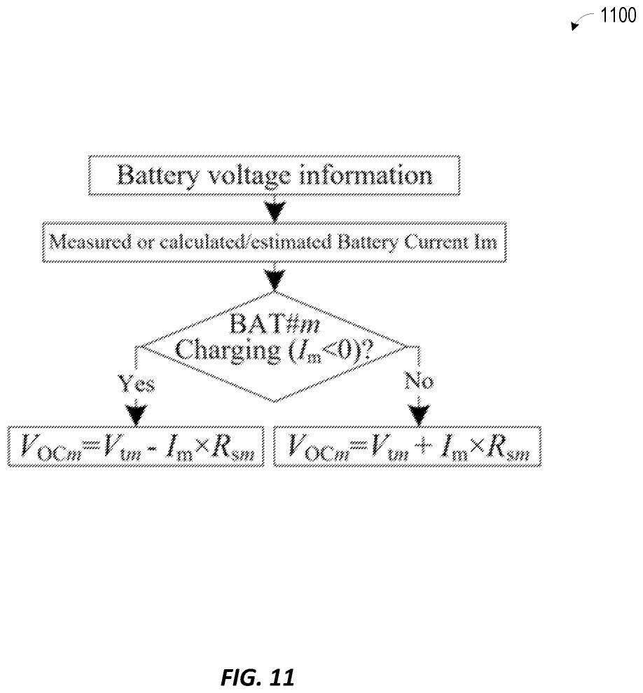

Referring now to FIG. 11, a schematic diagram depicting an example method 1100 for estimating the open circuit voltage of each battery cell by adjusting the value of the terminal voltage Vₜ is depicted. For two adjacent cells, the charges are moved from one cell to the other during balancing operation and therefore one battery is discharging and the other is charging. The voltage drop for the m^{th} battery cell in the battery pack, given by Iₘ×Rₛₘ, is added to the m^{th} battery cell terminal voltage during discharging and is subtracted from the m^{th} battery cell terminal voltage during charging. For battery cells that are under discharge operation (positive battery current), the voltage drop Iₘ×Rₛₘ is positive which yields Vₜ smaller than V_{OC}. Therefore, for discharging cells, the voltage drop is added to the sensed value of the terminal voltage. For battery cells under charging operation (negative battery current), the voltage drop Iₘ×Rₛₘ is negative which makes Vₜ larger than V_{OC}. Therefore, for charging cells, the voltage drop is subtracted from the sensed value of the terminal voltage. The calculated open circuit voltage values (using either datasheet value of Rₛ or real-time estimated value of Rₛ) can be then used (as described in connection with FIG. 8A) to determine the inductor current direction and to decide on enabling/disabling the switches.

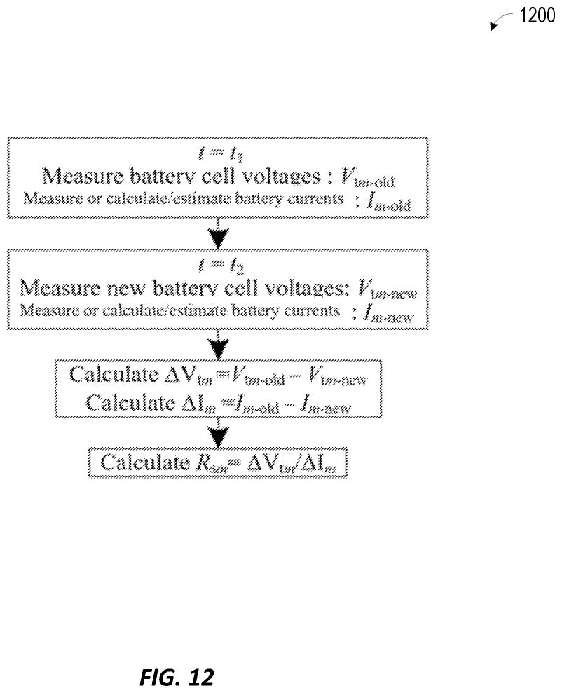

Referring now to FIG. 12, a schematic diagram depicting an example method 1200 is provided. The series resistance value of each battery cell can optionally be estimated (as an alternative to using predetermined values) during real time operation to be used for open circuit voltage estimation. The presented controller commands a small inductor current change (ΔI_{L} step in value) and measure the corresponding resulted changes in battery voltage (ΔVₜₘ) and battery cell current ΔIₘ as depicted in FIG. 12. At t=t₁, the battery cells' terminal voltages (V_{t1-old}, V_{t2-old}, V_{t3-old}, . . . V_{tn-old}) are measured and the battery cells' currents (I_{1-old}, I_{2-old}, I_{3-old}, . . . I_{n-old}) are measured or estimated/calculated using. At t=t₂, (which is a time after a current step ΔI_{L} in the inductor current is commanded by the controller) the battery cells' terminal voltages (V_{t1-new}, V_{t2-new}, V_{t3-new}, . . . V_{tn-new}) are measured and the battery cells' currents (I_{1-new}, I_{2-new}, I_{3-new}, . . . I_{n-new}) are measured or calculated/estimated. Then, Ohms' Law is used to calculate the resistance of each battery cell. Optionally and alternatively, an impedance or resistance measurement device can be used.

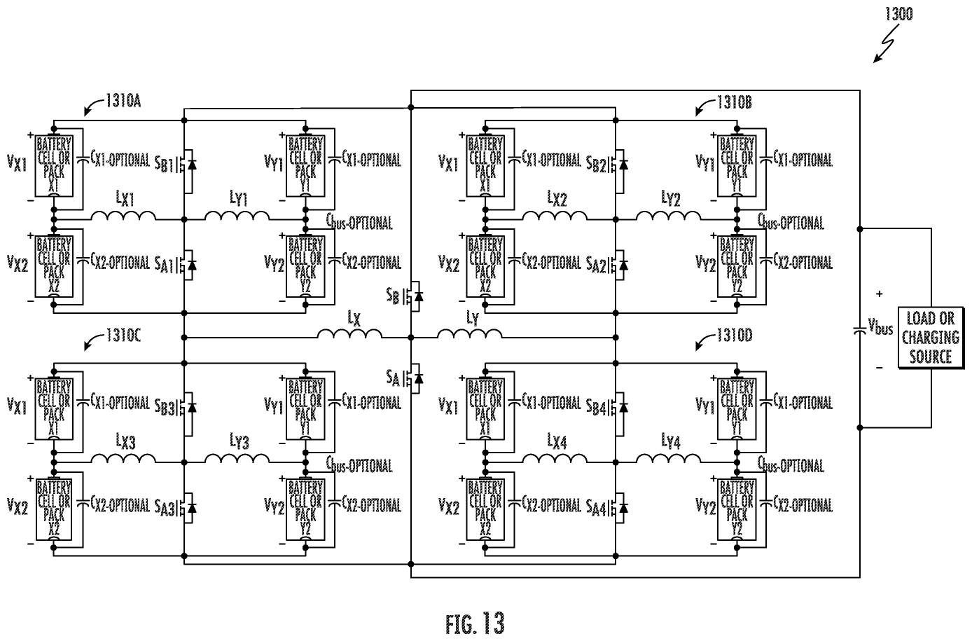

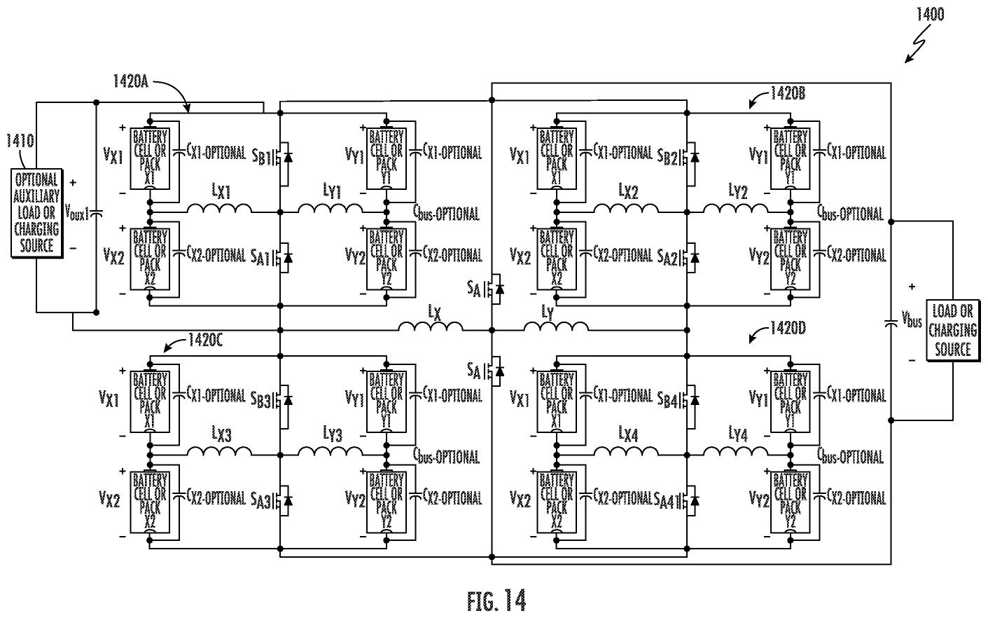

Referring now to FIGS. 13 and 14, schematic diagrams of adaptive power system circuit topologies 1300, 1400 are shown. In FIG. 14, an auxiliary load or charging source 1410 is provided for one of the sets of four batteries (i.e., set in top right corner). This is in addition to the load or charging source associated with the system circuit topology 1400. This disclosure contemplates that an auxiliary load or charging source can be provided for one or more of the sets of four batteries.

The system of FIG. 1 (with one to four batteries) is used here to form a battery block that one to four of it can be used in the same balancing and regulation configuration using another two switches and inductor(s). For example, FIG. 13 shows four battery blocks (top left battery block 1310A, top right battery block 1310B, bottom left battery block 1310C and bottom right battery block 1310D, each of which is based on FIG. 1) where two switches and inductor(s) are used to balance the charge or energy/power of the four battery blocks using the methods described earlier for FIG. 1 through FIG. 10. In other words, each of the four battery blocks has a controller that balances and regulates its own one to four batteries and a similar controller is used to balance and regulate the four battery blocks. FIG. 13 (or FIG. 14) itself can also become a larger battery block and one to four of it is used in the same manner. In this way, there the system can have larger number of batteries connected in a hierarchical manner. It should be understood that four battery blocks are provided only as an example. This disclosure contemplates providing a system with more or less than four battery blocks.

Similar to FIG. 13, FIG. 14 shows four battery blocks (top left battery block 1420A, top right battery block 1420B, bottom left battery block 1420C and bottom right battery block 1420D, each of which is based on FIG. 1) where two switches and inductor(s) are used to balance the charge or energy/power of the four battery blocks using the methods described earlier for FIG. 1 through FIG. 10. In FIG. 14, each battery block can have addition discharging load or charging source in addition to the discharging load or charging sources at the main bus. In this case one or more battery might be charged or discharged at faster rate than the other batteries which results in imbalance which the controller can optionally balance again using the two switches and inductors.

It should be appreciated that the logical operations described herein with respect to the various figures may be implemented (1) as a sequence of computer implemented acts or program modules (i.e., software) running on a computing device (e.g., the computing device described in FIG. 15), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 15, an example computing device 1500 upon which the methods described herein may be implemented is illustrated. It should be understood that the example computing device 1500 is only one example of a suitable computing environment upon which the methods described herein may be implemented. Optionally, the computing device 1500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1500 typically includes at least one processing unit 1506 and system memory 1504. Depending on the exact configuration and type of computing device, system memory 1504 may be volatile (such as random access memory (RAM)), non-volatile (such as read-only memory (ROM), flash memory, etc.), or some combination of the two. This most basic configuration is illustrated in FIG. 15 by dashed line 1502. The processing unit 1506 may be a standard programmable processor that performs arithmetic and logic operations necessary for operation of the computing device 1500. The computing device 1500 may also include a bus or other communication mechanism for communicating information among various components of the computing device 1500.

Computing device 1500 may have additional features/functionality. For example, computing device 1500 may include additional storage such as removable storage 1508 and non-removable storage 1510 including, but not limited to, magnetic or optical disks or tapes. Computing device 1500 may also contain network connection(s) 1516 that allow the device to communicate with other devices. Computing device 1500 may also have input device(s) 1514 such as a keyboard, mouse, touch screen, etc. Output device(s) 1512 such as a display, speakers, printer, etc. may also be included. The additional devices may be connected to the bus in order to facilitate communication of data among the components of the computing device 1500. All these devices are well known in the art and need not be discussed at length here.

The processing unit 1506 may be configured to execute program code encoded in tangible, computer-readable media. Tangible, computer-readable media refers to any media that is capable of providing data that causes the computing device 1500 (i.e., a machine) to operate in a particular fashion. Various computer-readable media may be utilized to provide instructions to the processing unit 1506 for execution. Example tangible, computer-readable media may include, but is not limited to, volatile media, non-volatile media, removable media and non-removable media implemented in any method or technology for storage of information such as computer readable instructions, data structures, program modules or other data. System memory 1504, removable storage 1508, and non-removable storage 1510 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1506 may execute program code stored in the system memory 1504. For example, the bus may carry data to the system memory 1504, from which the processing unit 1506 receives and executes instructions. The data received by the system memory 1504 may optionally be stored on the removable storage 1508 or the non-removable storage 1510 before or after execution by the processing unit 1506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An adaptive power system comprising:
a plurality of power sources;
a state-of-charge (SOC) circuit comprising a plurality of switches and at least one inductor, wherein the plurality of switches comprises first and second switches; and
a controller operably coupled to the plurality of switches, the controller being configured to operate the plurality of switches in a first mode and a second mode to balance a respective SOC of each of the plurality of power sources.

2. The system of claim 1, wherein the plurality of power sources comprises four power sources or less.

3. (canceled)

4. (canceled)

5. The system of claim 1, further comprising at least one open circuit terminal that corresponds to a disconnected power source.

6. The system of claim 5, wherein the controller is configured to compensate for the disconnected power source to operate the plurality of switches to generate a regulated voltage between the at least one open circuit terminal while balancing the respective SOC of each of the plurality of power sources.

7. The system of claim 1, wherein the plurality of power sources includes first, second, third, and fourth power sources, and wherein the first and second power sources are connected in series, the third and fourth power sources are connected in series, and the series-connected first and second power sources are connected in parallel with the series-connected third and fourth power sources.

8. (canceled)

9. The system of claim 1, wherein the plurality of switches comprises only the first and second switches.

10. (canceled)

11. The system of claim 1, wherein the first mode is a switching mode, the controller being configured to turn the plurality of switches ON and OFF in the switching mode.

12. The system of claim 11, wherein the controller is configured to select a duty cycle for the switching mode, the duty cycle controlling an amount of charge transfer among the plurality of power sources.

13. The system of claim 11, wherein the first mode is configured to balance the respective SOC of one or more vertically-connected power sources of the plurality of power sources, and wherein the second mode is configured to balance the respective SOC of one or more horizontally-connected power sources of the plurality of power sources.

14. The system of claim 1, wherein the second mode is a non-switching mode, the controller being configured to maintain the plurality of switches OFF in the non-switching mode.

15. (canceled)

16. (canceled)

17. The system of claim 1, wherein the controller is further configured to alternate between the first and second modes responsive to a respective voltage and/or SOC of each of the plurality of power sources.

18. The system of claim 17, wherein the controller is further configured to set a current value of the at least one inductor responsive to the respective voltage and/or SOC of each of the plurality of power sources to maximize efficiency and/or minimize power loss.

19. (canceled)

20. The system of claim 1, wherein the at least one inductor is a center-tapped inductor or coupled inductors.

21. (canceled)

22. (canceled)

23. The system of claim 1, wherein the at least one inductor comprises a plurality of inductors that share a magnetic core.

24. The system of claim 1, wherein the SOC circuit further comprises a first wiring for electrically connecting the plurality of switches to the plurality of power sources.

25. The system of claim 24, further comprising a load circuit comprising a second wiring and a load, the second wiring for electrically connecting the load to the plurality of power sources.

26. (canceled)

27. The system of claim 24, wherein the first wiring is configured to carry a SOC balancing current, and wherein the second wiring is configured to carry a load current or a charging current.

28. (canceled)

29. The system of claim 1, wherein each of the plurality of power sources comprise at least one of a battery cell, a battery pack, a super/ultra capacitor, a direct current (DC) micro grid, or a photovoltaic (PV) cell.

30. (canceled)

31. (canceled)

32. An adaptive power system comprising:
a plurality of power sources;
a state-of-charge (SOC) circuit comprising a plurality of switches and at least one inductor, wherein the plurality of switches comprises first and second switches; and
a controller operably coupled to the plurality of switches, the controller being configured to operate the plurality of switches in a first mode and a second mode to balance a respective SOC of each of the plurality of power sources.

33. An adaptive power system comprising:
a plurality of power sources, wherein the plurality of power sources comprises four power sources or less;
a state-of-charge (SOC) circuit consisting essentially of:
two switches corresponding to the plurality of power sources,
at least one inductor corresponding to the plurality of power sources, and
a wiring for electrically connecting the two switches and the at least one inductor to the plurality of power sources; and
a controller operably coupled to the two switches, the controller being configured to operate the two switches in a first mode and a second mode to balance a respective SOC of each of the plurality of power sources.

34. (canceled)

35. (canceled)

36. (canceled)
